(19) United States
(12) Patent Application Publication
(10) Pub. No.: US 2016/0065459 A1
(43) Pub. Date: Mar. 3, 2016

(54) METHOD AND APPARATUS FOR PERFORMING PROTECTION SWITCHING ADAPTIVELY ON MPLS (MULTI-PROTOCOL LABEL SWITCHING)- TP (TRANSPORT PROFILE) PACKET TRANSPORT NETWORK

(71) Applicant: ELECTRONICS AND TELECOMMUNICATIONS RESEARCH INSTITUTE, Daejeon (KR)

(72) Inventors: Yeon Cheol RYOO, Daejeon (KR); Dae Ub KIM, Daejeon (KR)

(21) Appl. No.: 14/739,304

(22) Filed: Jun. 15, 2015

(30) Foreign Application Priority Data
Aug. 28, 2014 (KR) 10-2014-0113441

(51) Int. Cl. H04L 12/723; H04L 12/933

(52) U.S. Cl. CPC H04L 45/50; H04L 49/102

(57) ABSTRACT

Provided herein is a method and apparatus for adaptively performing protection switching in an MPLS-TP packet transport network, the method including: receiving, by a protection switching adaptation apparatus, the protection switching message from a transmitting node; in response to the protection switching message being not interpretable based on a protection switching engine of a receiving node, converting, by the protection switching adaptation apparatus, the protection switching message to generate a converted protection switching message, and transmitting the converted protection switching message to the receiving node; and interpreting, by the receiving node, the converted protection switching message based on the protection switching engine to perform a protection switching process.

### CROSS-REFERENCE TO RELATED APPLICATION

The present application claims priority to Korean patent application number 10-2014-0113441, filed on Aug. 28, 2014, the entire disclosure of which is incorporated herein in its entirety by reference.

### BACKGROUND

1. Field of Invention

Various embodiments of the present disclosure relate to a network, and more particularly to a method and apparatus for performing protection switching adaptively on an MPLS (Multi-Protocol Label Switching)-TP (Transport Profile) packet transport network.

2. Description of Related Art

MPLS (Multi-Protocol Label Switching) technology is a technology standardized by the IETF (Internet Engineering Task Force). It is a technology of labeling packets of various services and providing connection-oriented packet services in order to improve the inefficiency of IP (Internet Protocol) packet switching.

As WDM (Wavelength Division Multiplexing) transport networks came into use a need arose for a connection-oriented transport function for packet services and various TDM (Time Division Multiplexing) services through optical networks. Also a need arose to construct a reliable transport infrastructure at minimal cost per bit for various client traffic (multi-services) and scalability in various service networks. To this end, the MPLS-TP JWT that is a joint working team of the ITU-T SG15 and the IETF implemented a standardization process.

The standardization process being implemented by the ITU-T SG15 and the IETF includes operation administration and maintenance (OAM), survivability, network management, and control plane protocol development.

An OAM function of an MPLS-TP network refers to a technology of detecting a network disorder and checking the state of the network. For example, functions such as continuity check, connectivity verification, remote defect indication, alarm indication signal, client signal fail, locked signal, packet loss measurement, and packet delay measurement are called OAM functions.

The two standardization groups: the ITU-T and the IETF started implementation of standardization of the MPLS-TP packet transport network technology, but the two groups had disagreements on MPLS-TP OAM functions. As a result, OAM technologies of both groups were defined as international standards, and thus two different packet frames were defined for the same OAM function. This caused a problem that when using an apparatus that does not support the same standard in an OAM setup section, the MPLS-TP OAM function cannot be supported. This would put limitations to network construction and scalability, and operation of equipments to certain standards.

### SUMMARY

A first purpose of the present disclosure is to provide a method for performing protection switching adaptively on an MPLS-TP packet transport network.

A second purpose of the present disclosure is to provide an apparatus for performing protection switching adaptively on an MPLS-TP packet transport network.

An embodiment of the present disclosure provides a method for receiving a protection switching message, the method including receiving, by a protection switching adaptation apparatus, the protection switching message from a transmitting node; in response to the protection switching message being not interpretable based on a protection switching engine of a receiving node, converting, by the protection switching adaptation apparatus, the protection switching message to generate a converted protection switching message, and transmitting the converted protection switching message to the receiving node; and interpreting, by the receiving node, the converted protection switching message based on the protection switching engine to perform a protection switching process. The method may further include in response to the protection switching message being interpretable based on the protection switching engine, transmitting, by the protection switching adaptation apparatus, the protection switching message to the receiving node. The converted protection switching message may include at least one second lower field each corresponding to each of a plurality of first lower fields included in the protection switching message, and the at least one second lower field may include information that the corresponding first lower field indicates. The receiving node may be a node that supports the G8131.1 standard, the transmitting node may be a node that supports the G8131.2 standard, the protection switching message may be an APS (automatic protection switching) message, and the converted protection switching message may be a PSC (protection state control) message. The receiving node may be a node that supports the standard, the transmitting node may be a node that supports the G8131.1 standard, the protection switching message may be an PSC (protection state control) message, and the converted protection switching message may be an APS (automatic protection switching) message.

Another embodiment of the present disclosure provides a protection switching adaptation apparatus for receiving a protection switching message, the apparatus including a translator configured to receive the protection switching message from a transmitting node, and the apparatus is configured to, in response to the protection switching message being not interpretable based on an protection switching engine of a receiving node, convert the protection switching message to generate a converted protection switching message, and transmit the converted protection switching message to the receiving node, the receiving node interpreting the converted protection switching message based on the protection switching engine. The translator may be configured such that, in response to the protection switching message being interpretable based on the protection switching engine, the protection switching adaptation apparatus transmits the protection switching message to the receiving node. The converted protection switching message may include at least one second lower field each corresponding to each of a plurality of first lower fields included in the protection switching message, and the at least one second lower field may include information that the corresponding first lower field indicates. The receiving node may be a node that supports the G8131.1 standard, the transmitting node may be a node that supports the G8131.2 standard, the protection switching message may be an APS (automatic protection switching) message, and the converted protection switching message may be a PSC (protection state control) message. The receiving node may be a node that supports the G8131.2 standard, the transmitting node may be a node that supports the G8131.1 standard, the protection switching message may be an PSC (protection state control) message, and the converted protection switching message may be an APS (automatic protection switching) message.

As aforementioned, by using the method and apparatus for adaptively performing protection switching in an MPLS-TP packet transport network according to various embodiments of the present disclosure, in a case of using an apparatus wherein the protection switching protocols of the nodes in the MPLS-TP network support different standards G.8131.1, G.8131.2, it is possible to add a protection adaptation function such as the translator, and remove limitations to the protection switching protocol of each node, and convert the protection message format into a message format appropriate to the transmitting node and receiving node, thereby supporting a smooth MPLS-TP protection switching function between nodes that support different standards.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view illustrating a concept of an MPLS-TP based carrier Ethernet transport network;

FIG. 2 is a view illustrating a concept of a transport structure of a protection switching message in the G.8131.1 standard and the G.8131.2 standard;

FIG. 3 is view illustrating a concept of a method for receiving a protection switching message through a translator according to an embodiment of the present disclosure;

FIG. 4 is a view illustrating a concept of a method for transmitting the protection switching message through the translator according to the embodiment of the present disclosure;

FIG. 5 is a view illustrating a concept of a method for converting a protection switching PDU according to the embodiment of the present disclosure;

FIG. 6 is a flowchart of the method for converting the protection switching message according to the embodiment of the present disclosure;

FIG. 7 is a flowchart of the method for converting the protection switching message according to the embodiment of the present disclosure; and

FIG. 8 is a view illustrating a concept of the translator according to the embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

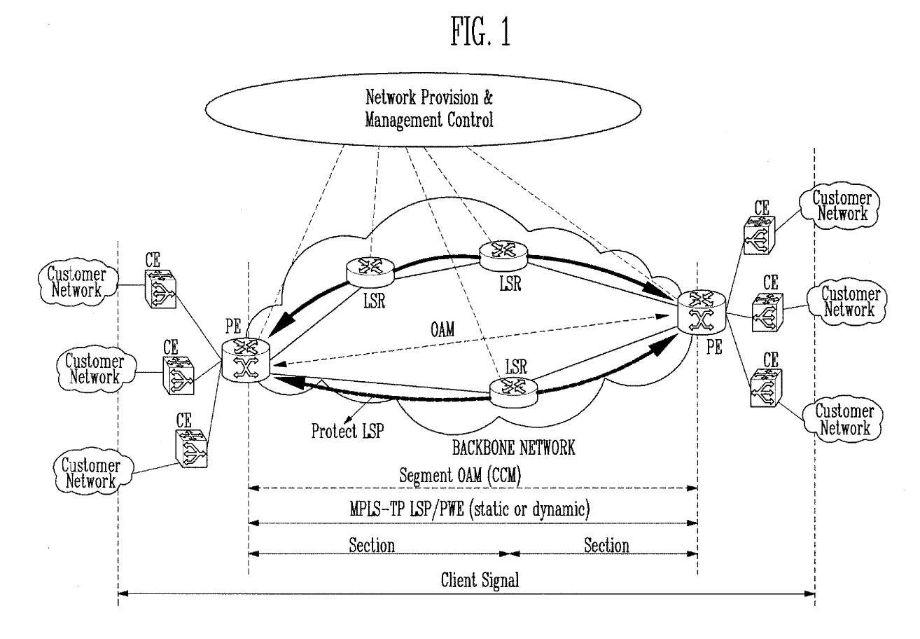

FIG. 1 is a view illustrating a concept of an MPLS-TP based carrier Ethernet transport network.

Referring to FIG. 1, the MPLS (multi-protocol label switching)-TP (transport profile) based carrier Ethernet transport network may consist of a PE (provider edge) node for connecting a backbone network and a customer network, and an LSR (label switch router) node for providing a line connecting function in the backbone network. The PE node may be positioned in an edge region of the backbone network. The PE node may be connected to a CE (customer edge) node. The PE node may attach a label to an MPLS frame and pass it on to the backbone network.

The LSR (label switching router) may be positioned in a core region of the backbone network, and may transmit the frame to which the label is attached and which is received from the PE node to another LSR or another PE node. Between PE node ends, a virtual line LSP (label switched path) may be set up dynamically/statically.

Nodes that form the backbone network that is set up between the PE node ends may be provisioned by a control protocol or may be directly configured by a manager. Furthermore, an LSP may be set up based on all topology information of the backbone network, and between edge nodes of the LSP that is set up, an MEP (maintenance association endpoint) and RMEP (Remote MEP) may be created so as to transmit a CCM (Continuity Check Message) between the ends on a regular basis.

The CCM message that the MEP transmits may be received by the RMEP to monitor a state of LSP connection. For example, when an error occurs in a node or link positioned in a path set up, the RMEP cannot receive a CCM message, and when three or more CCM messages are not received, the RMEP determines that there is an error in the link of the corresponding LSP, and in order to secure service reliability, the RMEP performs a fast LSP protection switching function of converting to a backup link of within 50 ms that has its basis on an existing circuit line technology.

When such an error occurs in the MPLS-TP network and traffic transport is stopped, the protection switching method is one way to pass on the traffic through another path as quickly as possible.

The current MPLS (multiprotocol label switching)-TP (transport profile) packet transport network technology defines an APS (Automatic Protection Switching) message or a PSC (Protection State Control) message for protection switching.

The IETF draft draft-zulr-mpls-tp-linear-protection-switching-03.txt, ITU-T G.8131.1 defines MPLS-TP Linear Protection Switching for managing switching states and performing path protection switching based on an APS message. Furthermore, the IETF RFC6378, ITU-T G.8131.2 defines a method for managing a state of switching and path protection switching using a PSC message.

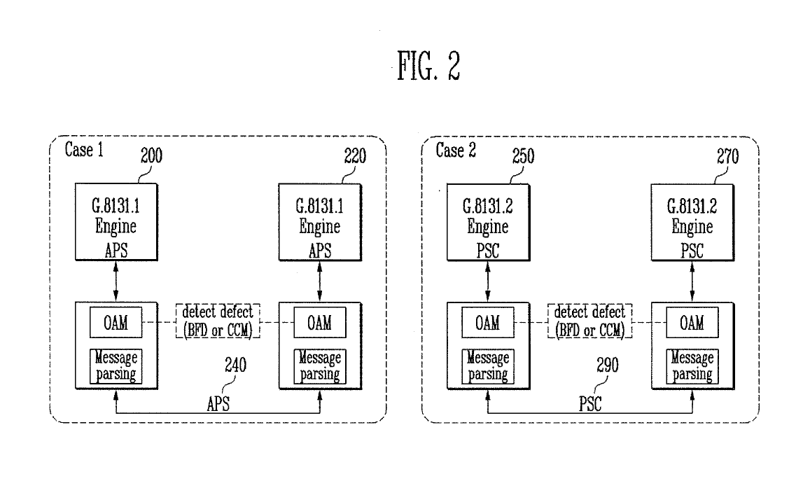

FIG. 2 is a view illustrating a concept of a transport structure of a protection switching message in the G.8131.1 standard and the G.8131.2 standard.

Referring to FIG. 2, when an error occurs in the MPLS-TP network, a state of the error may be passed on to a protection switching engine through an OAM (operation administration and maintenance) function of the MPLS-TP. The protection switching engine will generate a protection switching message corresponding to the network error, and transmit the protection switching message to a node that needs change of path.

(a) of FIG. 2 illustrating a node 200 that transmits a protection switching message and a node 220 that receives the protection switching message shows a case where both protection switching engines support the G.8131.1 standard. In such a case, both nodes may perform the protection switching function based on an APS message 240.

(b) of FIG. 2 illustrating a node 250 that transmits a protection switching message and a node 270 that receives the protection switching message shows a case where both protection switching engines support the G.8131.2 standard. In such a case, both nodes may perform the protection switching function based on a PSC message 290.

FIG. 2 illustrates cases where a node transmitting a protection switching message and a node receiving the protection switching message support a same standard. However, there may be a case where a node transmitting a protection switching message and a node receiving the protection switching message support different standards. For example, a protection switching engine of a node that transmits a protection switching message may support the G.8131.1, whereas a protection switching engine of a node that receives the protection switching message supports the G.8131.2.

In such a case, the transmitting node may generate an APS message as the protection switching message, and the receiving node may wait to receive a PSC message as the protection switching message. Therefore, there occurs a problem where the transmitting node and the receiving node fail to process the protection switching message due to their different formats of the protection switching message, and drop the same.

Hereinafter, explanation will be made on an apparatus and method for converting a format of a protection switching message so as to support a protection switching function between nodes that operate based on different protection switching protocols according to an embodiment of the present disclosure.

According to the embodiment of the present disclosure, a translator may be used to support the protection switching function between the nodes that support different standards (G.8131.1, G.8131.2) in a network. The translator may convert a message format for transmitting and receiving the protection switching message regardless of the type of protection switching engine of each node. That is, using the translator, it is possible to perform a protection adaptation function, thereby supporting the MPLS-TP protection switching smoothly.

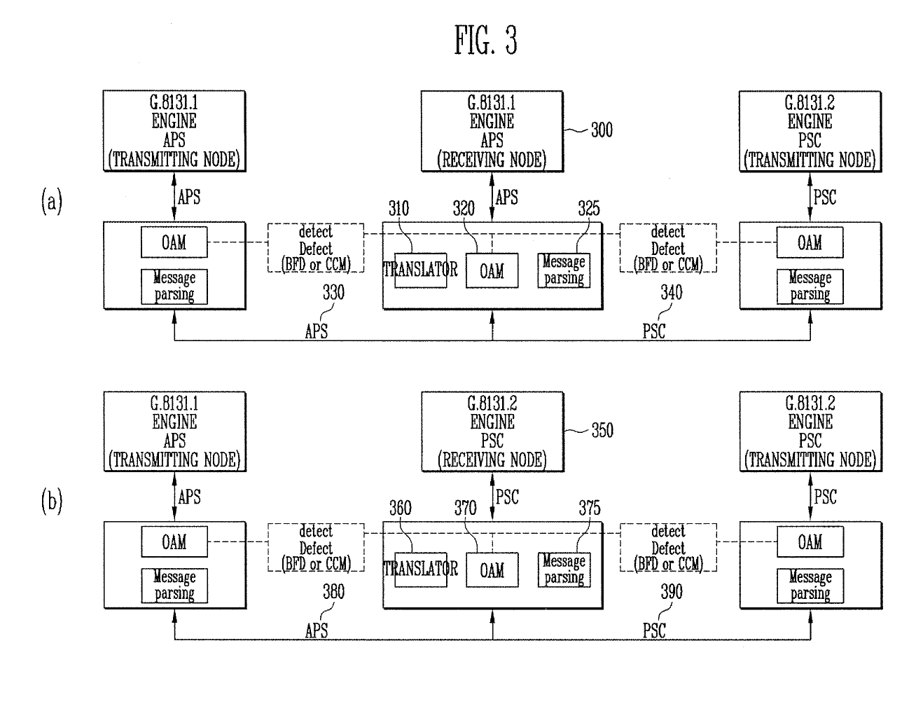

FIG. 3 illustrates a concept of a method for receiving a protection switching message in the receiving node through the translator according to the embodiment of the present disclosure.

FIG. 3 illustrates a method wherein the receiving node performs a protection switching function with a node that supports a different standard in the MPLS-TP network using the translator when receiving a protection switching message. The translator may convert the format of the protection switching message.

Referring to FIG. 3, the protection switching adaptation apparatus may include in an existing protection switching message transport structure the translator for converting a format of a protection switching message. Using the translator, it is possible to convert the protection switching message such that it satisfies the standard that the protection switching engine supports and then transmit the converted protection switching message to the protection switching engine of the receiving node.

The method for receiving the MPLS-TP protection switching message (hereinafter referred to as the protection switching message) in the MPLS-TP network using the protection switching adaptation apparatus that includes the translator will be explained hereinafter.

The protection switching message being received by the receiving node may be a protection switching message that has been converted to satisfy the standard of the receiving node or a protection switching message that has been bypassed without being converted through the translator. That is, when necessary, using the method of converting, by the translator, a received protection switching message such that it satisfies the protection switching engine of the receiving node and then transmitting the converted protection switching message, it is possible to support the protection switching function even when the protection switching engine of the receiving node and the protection switching engine of the transmitting node support different standards.

(a) of FIG. 3 illustrates a case where the protection switching engine of the receiving node 300 supports the G.8131.1 standard.

The protection switching adaptation apparatus may confirm a GAL value and G-Ach value of the message received. In a case where the GAL value of the received message is 13 and the G-Ach value is 8902, the protection switching adaptation apparatus may perceive the received message as an OAM message and transmit it to an OAM engine.

The OAM engine 320 may confirm an OpCode value of the received message. In a case where the OpCode of the received message is 39, the OAM engine 320 may perceive the received message as an APS message and transmit the APS message to the translator 310. Other than the method of transmitting the protection switching message to the translator 310 via the OAM engine 320 as mentioned above, the protection switching message may be transmitted to the translator 310 without going through the OAM engine 320. For example, the protection switching adaptation apparatus may search the OpCode of the received message through a message parsing process 325, and when the OpCode of the message is 39, the protection switching adaptation apparatus may perceive the message as an APS message and transmit it directly to the translator.

Such a process where the protection switching message is passed on to the translator 310 is a mere example. The process of transmitting a protection switching message to the translator 310 may be performed through various paths in various methods according to apparatus operation standards.

In a case where the protection switching message transmitted to the translator 310 is an APS message 330, and the protection switching engine of the receiving node 300 is the G.8131.1, since the same standard is being supported, the received message may be bypassed without being subjected to a conversion in the translator 310. The translator 310 may transmit an APS PDU part of the received APS message 330 to the protection switching engine and perform the protection switching function.

In a case where the protection switching message transmitted to the translator 310 is a PSC message 340, and the protection switching engine of the receiving node is the G.8131.1, the protection switching engine of the receiving node may receive the protection switching message converted by the translator 310. The translator 310 may convert a PSC PDU part of the PSC message 340 into an APS PDU format that is a format that the protection switching engine of the receiving node 300 supports, and transmit it to the protection switching engine of the receiving node 300. The method of converting a PSC PDU part of the PSC message 340 into an APS PDU format will be explained hereinafter.

(b) of FIG. 3 illustrates a case where the protection switching engine of the receiving node 350 supports the G.8131.2 standard.

The protection switching adaptation apparatus may confirm the GAL and G-Ach value of the received message. In a case where the GAL value of the received message is 13 and the G-Ach value is 0x0024, the protection switching adaptation apparatus may perceive the received message as an OAM message and PSC message. In a case where the protection switching adaptation apparatus perceives the received message as the PSC message, the protection switching adaptation apparatus may transmit the received message to the translator 350 either through the OAM engine 370 or directly to the translator 360. As aforementioned, the process of the protection switching message being transmitted to the translator 360 is a mere example. Besides the above, the process of transmitting the protection switching message to the translator 360 may be performed through various paths in various methods according to the apparatus operation standards.

In a case where the protection switching message transmitted to the translator 360 is a PSC message 390 and the protection switching engine of the receiving node 350 is the G.8131.2, since a same standard is being supported, the received message may be bypassed without being subjected to a conversion in the translator 360, and be transmitted to the protection switching engine. That is, the translator 360 may transmit a PSC PDU part of the PSC message to the protection switching engine of the receiving node 350 and perform the protection switching function.

In a case where the protection switching message transmitted to the translator 360 is an APS message 380 and the protection switching engine of the receiving node 350 is the G.8131.2, the protection switching engine of the receiving node 350 may receive a protection switching message converted by the translator 360. The translator 360 may convert an APS PDU part of the APS message 380 into a PSC PDU format that is the format that the protection switching engine support of the receiving node 350 supports and transmit it to the protection switching engine of the receiving node 350. The method of converting the APS PDU part of the APS message 380 into the PSC PDU format will be explained hereinafter.

The protection switching engine of the receiving node may process the protection switching message transmitted through the translator in the same manner as the transmitting node that supports the same standard and perform the protection switching process.

The aforementioned conversion method is a format conversion method of the protection switching message being performed in the receiving node, but the format of the protection switching message may be converted in not only the receiving but also in the transmitting node. Hereinafter, explanation will be made on a method for converting a message to satisfy the standard that the protection switching engine of the receiving node supports in the transmitting node when transmitting the message from the transmitting node.

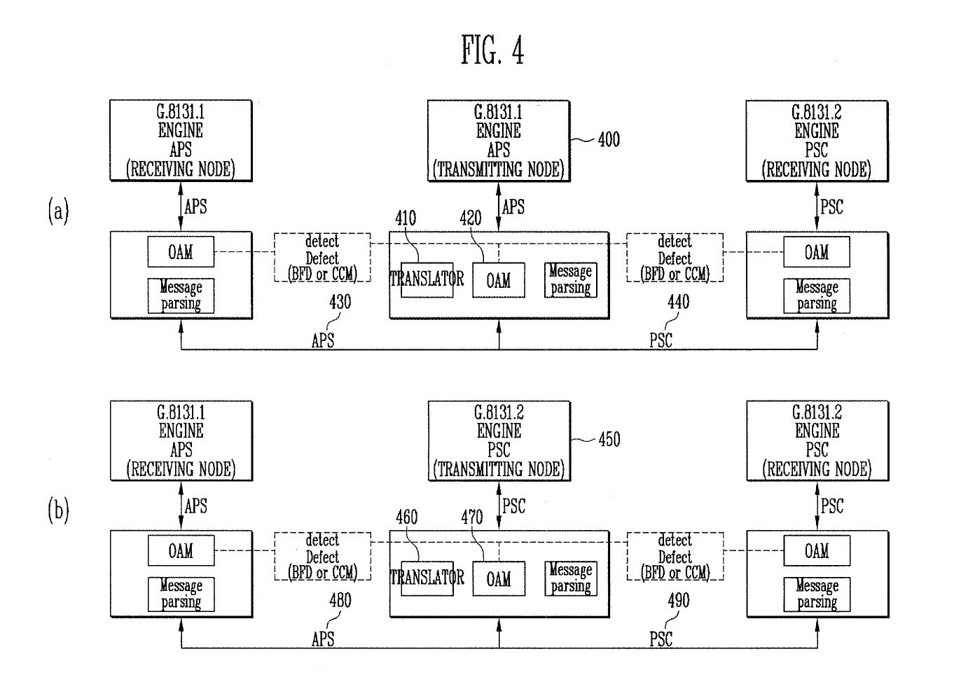

FIG. 4 is a view illustrating a concept of a method for transmitting a protection switching message through the translator according to an embodiment of the present disclosure.

FIG. 4 illustrates a method for supporting the protection switching function between nodes that use protection switching engines that support different standards in the MPLS-TP network by using the translator when transmitting a message. The translator may convert the format of a protection switching message.

Referring to FIG. 4, in a case of transmitting a protection switching message using the protection switching adaptation apparatus, the transmitting node may generate a protection switching message that supports a different standard from the protection switching engine of the transmitting node based on the translator and transmit the same.

(a) of FIG. 4 illustrates a case where the protection switching engine of the transmitting node 400 is the G.8131.1 engine.

In a case where the protection switching engine of the receiving node is the G.8131.1 engine, the transmitting node 400 may transmit an APS PDU generated to the translator 410 as it is, input 8902 as a G-Ach value, and input 13 as a GAL value, and generate an APS message 430. The APS message 430 generated may be transmitted to the receiving node through the OAM engine 420. Otherwise, the APS message 430 generated may be transmitted to the receiving node without going through the OAM engine. As aforementioned, the process where the protection switching message is transmitted to the translator is a mere example. Besides the above, the process of transmitting the protection switching message to the translator may be performed through various paths in various methods according to the apparatus operation standard.

In a case where the protection switching engine of the receiving node is the G.8131.2 engine, the transmitting node 400 may transmit the APS PDU generated to the translator 410. In the translator 410, the APS PDU may be converted into a PSC PDU, 0x0024 may be input as the G-Ach value, and 13 may be input as the GAL value, to generate a PSC message 440, and the PSC message 400 may be transmitted to the receiving node via the OAM engine 420. Otherwise, the PSC message 440 may be transmitted directly to the receiving node from the translator 410 without going through the OAM engine 420. As aforementioned, the process of the protection switching message being transmitted to the translator 410 is a mere example. Besides the above, the process of transmitting the protection switching message to the translator 410 may be performed through various paths in various methods according to the apparatus operation standard.

(b) of FIG. 4 illustrates a case where the protection switching engine of the transmitting node 450 is the G.8131.2 engine.

In a case where the protection switching engine of the receiving node is the G.8131.2 engine, the transmitting node 450 transmits the generated PSC PDU to the translator 460 as it is, input 0x0024 as a G-Ach value, and input 13 as a GAL value, and generate a PSC message 490. The PSC message 490 generated may be transmitted to the receiving node through the OAM engine 460. Otherwise, the PSC message 490 generated may be transmitted to the receiving node without going through the OAM engine 470. As aforementioned, the process of transmitting the protection switching message to the translator 460 is a mere example. Besides the above, the process of transmitting the protection switching message to the translator 460 may be performed through various paths in various methods according to the apparatus operation standard.

In a case where the protection switching engine of the receiving node is the G.8131.1 engine, the transmitting node 450 may transmit the PSC PDU generated to the translator 460. The translator 460 may convert the PSC PDU into an APS PDU, and input 8902 as a G-Ach value, and input 13 as a GAL value to generate an APS message 480 to be transmitted to the receiving node via the OAM engine 470. Otherwise, the APS message 480 may be transmitted to the receiving node from the translator 460 directly without going through the OAM engine 470. As aforementioned, the process of transmitting the protection switching message to the translator is a mere example. The process of transmitting the protection switching message to the translator may be performed through various paths in various methods according to the apparatus operation standard.

The receiving node that received the generated protection switching message using the translator may perceive that the transmitting node uses a protection switching engine of the same standard, and may support the protection switching function through the protection switching message in the same manner as when using a single engine.

FIG. 5 is a view illustrating a concept of the method for converting the protection switching PDU according to the embodiment of the present disclosure.

The protection switching PDU may be converted from an APS PDU into a PSC PDU, or from a PSC PDU into an APS PDU.

FIG. 5 illustrates formats of an APS message and PSC message.

In a field included in each APS message and the PSC message, a corresponding field may exist. According to the embodiment, in the corresponding field, a mutual conversion between an APS PDU and a PSC PDU may be performed. A relationship on the corresponding field may be predetermined. In a case where there does not exist a mutually corresponding field, the information may be filled as null or may be dropped, or may be exchanged between fields that do not correspond.

Referring to FIG. 5, for example, an ‘OpCode’ of the APS message and a ‘PSC-CT’ of the PSC message be correspond to each other. Likewise, a ‘request/state’ of the APS message and a ‘request’ of the PSC message may correspond to each other. Mapping between the information of each field may be performed in the translator. That is, although the message format of the APS message and the PSC message are different from each other, the data value of the corresponding field for performing the protection switching has a similar value. Using this principle, it is possible to appropriately change the matching protection switching PDU value and perform the conversion of the protection switching PDU.

Using such a method, it is possible to resolve the problem of incompatibility of protection switching functions that may occur in a case of using an apparatus wherein the protection switching protocols of the nodes in the MPLS-TP network support different standards G.8131.1, G.8131.2. It is possible to add a protection adaptation function based on the translator, and remove limitations to the protection switching protocol of each node, and convert the protection message format into a message format appropriate to the transmitting node and receiving node, thereby supporting a smooth MPLS-TP protection switching function between nodes that support different standards.

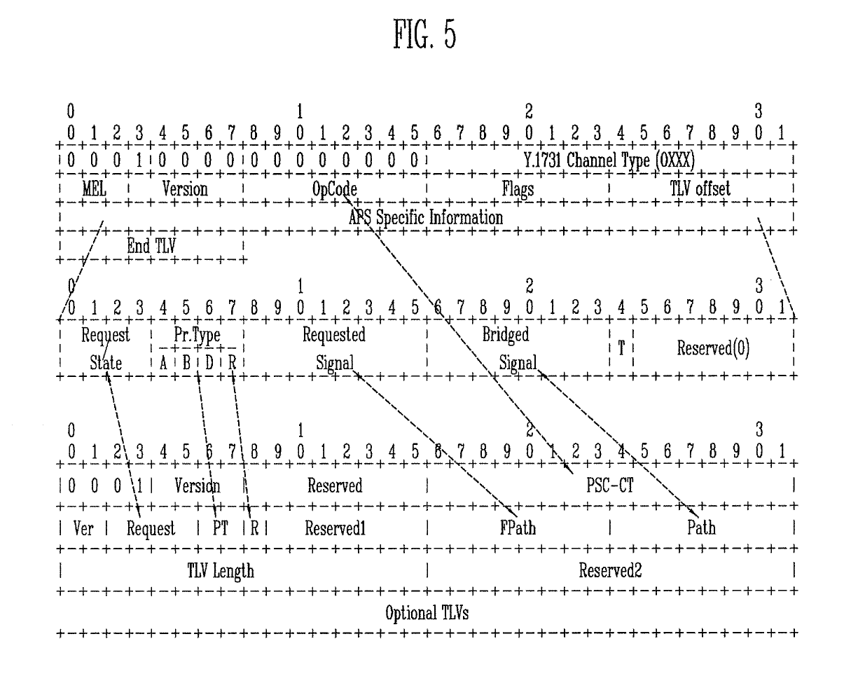

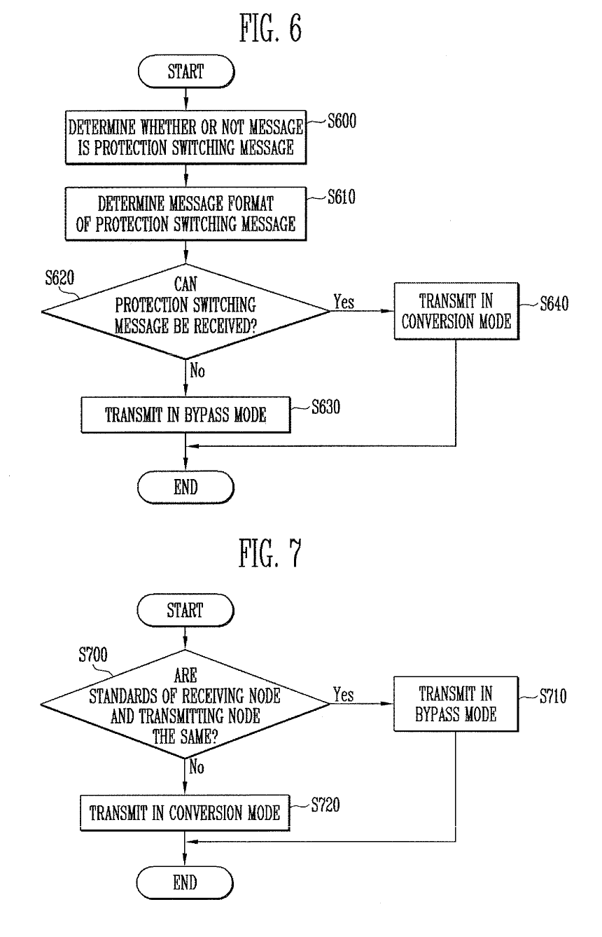

FIG. 6 is a flowchart illustrating a method for converting the protection switching message according to the embodiment of the present disclosure.

FIG. 6 illustrates a method for receiving the protection switching message in the receiving node using the protection switching adaptation apparatus.

Referring to FIG. 6, the apparatus determines whether or not a message is a protection switching message (S600).

The apparatus may determine a field of the received message (for example, GAL and/or G-Ach) to determine whether or not the message is a protection switching message.

In response to the message being a protection switching message, the apparatus determines a message format of the protection switching message (S610).

In response to the message received being the protection switching message, it is possible to determine whether or not the protection switching message is an APS message that supports the G8131.1 or a PSC message that supports the G8131.2.

The apparatus determines whether or not the protection switching message may be decoded in the protection switching engine of the receiving node (S620).

By determining whether the standard that the protection switching message supports is the same as the standard that the protection switching engine of the receiving node supports, the apparatus may determine whether or not the protection switching message may be decoded or interpreted in the protection switching engine of the receiving node.

The apparatus transmits the protection switching message to the receiving node in a bypass mode (S630).

In response to the standard that the protection switching message supports being the same as the standard that the protection switching engine of the receiving node supports, the protection switching message may be transmitted directly to the protection switching engine of the receiving node in the bypass mode without being subjected to a conversion in the translator.

The protection switching message is transmitted to the receiving node in a conversion mode (S640).

In response to the standard that the protection switching message supports and the standard that the protection switching engine of the receiving node not being the same, the translator may perform conversion in the conversion mode and transmit it to the protection switching engine of the receiving node.

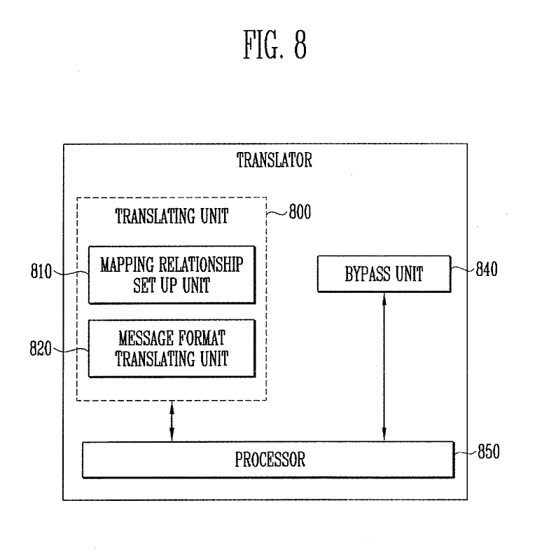

FIG. 7 is a flowchart illustrating the method for converting the protection switching message according to the embodiment of the present disclosure.

FIG. 7 illustrates a method for the transmitting node to transmit the protection switching message using the protection switching adaptation apparatus.

Referring to FIG. 7, the apparatus determines whether or not the protection switching engine of the receiving node supports the same standard as the protection switching engine of the transmitting node (S700).

In response to the protection switching engine of the receiving node supporting the same standard as the protection switching engine of the transmitting node, the apparatus transmits the protection switching message to the receiving node in the bypass mode (S710).

In response to the protection switching engine of the receiving node supporting the same standard as the protection switching engine of the transmitting node, the transmitting node may transmit the generated protection switching message to the receiving node without performing any conversion.

In response to the protection switching engine of the receiving node not supporting the same standard as the protection switching engine of the transmitting node, the apparatus transmits the protection switching message converted in the conversion mode to the receiving node. (S720).

In response to the protection switching engine of the receiving node not supporting the same standard as the protection switching engine of the transmitting node, the transmitting node may perform conversion based on the translator and transmit the converted protection switching message to the receiving node.

FIG. 8 is a view of a concept illustrating the translator according to the embodiment of the present disclosure.

Referring to FIG. 8, the translator may include a bypass unit 840, translating unit 800, and processor 850, and the translating unit 800 may include a matching relationship set up unit 810. and a message format translating unit 820.

The bypass unit 840 may be configured to transmit the received the protection switching message to the transmitting node or receiving node in the bypass mode, in response to the conversion of the protection switching message not determined.

The translating unit 800 may be configured to convert the protection switching message in the conversion mode and transmit the converted protection switching message, in response to the conversion of the protection switching message determined.

The mapping relationship set up unit 810 may be configured to set up mapping information on the conversion relationship of the message being converted. The fields included in the APS message and PSC message may have a mapping relationship between each other in the case of conversion, and the information on such a mapping relationship may be stored in the mapping relationship set up unit 810.

The message format translating unit 820 may be configured to convert the message format based on the mapping relationship set up based on the mapping relationship set up unit 810. A lower field of the APS message and PSC message may be converted by the mapping relationship set up by the mapping relationship set up unit 810.

The processor 850 may be configured to control operations of the bypass unit 840 and translating unit 800.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for receiving a protection switching message, the method comprising:
receiving, by a protection switching adaptation apparatus, the protection switching message from a transmitting node;
in response to the protection switching message being not interpretable based on a protection switching engine of a receiving node, converting, by the protection switching adaptation apparatus, the protection switching message to generate a converted protection switching message, and transmitting the converted protection switching message to the receiving node; and
interpreting, by the receiving node, the converted protection switching message based on the protection switching engine to perform a protection switching process.

2. The method according to claim 1,
further comprising, in response to the protection switching message being interpretable based on the protection switching engine, transmitting, by the protection switching adaptation apparatus, the protection switching message to the receiving node.

3. The method according to claim 1,
wherein the converted protection switching message comprises at least one second lower field each corresponding to each of a plurality of first lower fields included in the protection switching message, and
the at least one second lower field includes information that the corresponding first lower field indicates.

4. The method according to claim 3,
wherein the receiving node is a node that supports the G8131.1 standard,
the transmitting node is a node that supports the G8131.2 standard,
the protection switching message is an APS (automatic protection switching) message, and
the converted protection switching message is a PSC (protection state control) message.

5. The method according to claim 3,
wherein the receiving node is a node that supports the G8131.2 standard,
the transmitting node is a node that supports the G8131.1 standard,
the protection switching message is an PSC (protection state control) message, and
the converted protection switching message is an APS (automatic protection switching) message.

6. A protection switching adaptation apparatus for receiving a protection switching message, the apparatus comprising:
a translator configured to receive the protection switching message from a transmitting node,
and the apparatus is configured to, in response to the protection switching message being not interpretable based on an protection switching engine of a receiving node, convert the protection switching message to generate a converted protection switching message, and transmit the converted protection switching message to the receiving node,
the receiving node interpreting the converted protection switching message based on the protection switching engine.

7. The apparatus according to claim 6,
wherein the translator is configured such that, in response to the protection switching message being interpretable based on the protection switching engine, the protection switching adaptation apparatus transmits the protection switching message to the receiving node.

8. The apparatus according to claim 6,
wherein the converted protection switching message comprises at least one second lower field each corresponding to each of a plurality of first lower fields included in the protection switching message, and
the at least one second lower field includes information that the corresponding first lower field indicates.

9. The apparatus according to claim 8,
wherein the receiving node is a node that supports the G8131.1 standard,
the transmitting node is a node that supports the G8131.2 standard,
the protection switching message is an APS (automatic protection switching) message, and
the converted protection switching message is a PSC (protection state control) message.

10. The apparatus according to claim 8,
wherein the receiving node is a node that supports the G8131.2 standard,
the transmitting node is a node that supports the G8131.1 standard,
the protection switching message is an PSC (protection state control) message, and
the converted protection switching message is an APS (automatic protection switching) message.
